(19) United States
(12) Patent Application Publication
(10) Pub. No.: US 2006/0045733 A1
(43) Pub. Date: Mar. 2, 2006

(54) Water turbine motor with outlet buffer reservoir

(75) Inventor: Ehud Nagler, Kiryat Tivon (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(73) Assignee: Hydro-Industries Tynat Ltd.

(21) Appl. No.: 10/928,155

(22) Filed: Aug. 30, 2004

(51) Int. Cl. F03B 1/04

(52) U.S. Cl. 415/202

(57) ABSTRACT

A water-powered turbine motor includes a casing having a bottom drainage opening, and a rotor having a plurality of blades rotatably mounted within the casing. Associated with the casing is an inlet nozzle for connection to an external source of water to generate a stream of water directed towards the blades so as to rotate the rotor. A reservoir is deployed beneath the bottom drainage opening for receiving water draining from the casing. A drainage outlet is formed in the reservoir for allowing drainage of water from the reservoir to a remote drain.

### FIELD AND BACKGROUND OF THE INVENTION

The present invention relates to water-powered turbine motors and, in particular, it concerns a domestic water turbine motor with an outlet buffer reservoir.

It is known to employ an impeller or turbine type motor for generating mechanical power from a fluid flow. These motors are driven by kinetic energy transferred from the flow of water hitting surfaces of impeller or turbine blades and causing them to turn. The power available from the water flow is a function of its momentum, and therefore proportional both to the flow rate of the water (mass or volume per unit time) and its velocity as it impinges on the blades.

Of particular relevance to the present invention are small water-driven motors of this type which are connected to a domestic water source to power various devices such as, but not limited to, hose reels. Examples of such motors may be found in U.S. Pat. No. 2,518,990 to Keener and U.S. Pat. No. 3,471,885 to McLoughlin et al. Both of these examples relate to applications where the water used to drive the motor is immediately employed for another purpose, either for irrigation or for cleaning a hose. In such cases, a high water flow rate can be used, thereby providing sufficient momentum for driving the motor even at relatively low velocities.

In other applications where the water used by the motor is not required for another purpose, it is desirable to achieve higher volumetric efficiency so as to reduce the quantity of water required by the system. This is done by increasing the velocity of the water impinging on the turbine blades so that the same output power can be derived from a lower flow rate. An example of a motor of this type, designated 10, is illustrated here in FIGS. 1-3. The water velocity is increased by employing a small-aperture nozzle 12 to generate one or more relatively high speed but low volume jet stream of water directed at the blades 14.

For household or garden applications, the water downstream of the motor must typically be drained to the nearest domestic drain, generally requiring a length of outlet hose 16 downstream of motor 10. This causes an outlet flow impedance which typically slows the initial water drainage rate significantly below the inlet flow rate of the motor. As a result, as illustrated in FIG. 3, a volume of water will tend to accumulate within the motor casing during use, causing drag on the turbine rotor. The water level in the motor casing continues to increase until sufficient pressure builds up within the casing to produce an outlet flow equal to the inlet flow. The back pressure built up within the casing also tends to reduce the pressure differential at the inlet nozzle, thereby reducing the velocity of the water jets. In some cases, the casing may become completely or nearly full of water, generating a large amount degree of drag on the blades turning in a water-filled space, and possibly also directly interfering with the path of the high-speed jet stream directed towards the blades. All of these effects result in greatly reduced power output and a loss of efficiency.

There is therefore a need for a water turbine motor employing a jet of water directed through air at blades of the turbine wherein effective drainage from the motor casing is ensured despite significant flow impedance in a drainage line from the motor.

### SUMMARY OF THE INVENTION

The present invention is a water turbine motor with an outlet buffer reservoir.

According to the teachings of the present invention there is provided, a water-powered turbine motor comprising: (a) a casing having a bottom drainage opening; (b) a rotor having a plurality of blades, the rotor being rotatably mounted within the casing; (c) an output shaft mechanically linked so as to rotate with the rotor; (d) an inlet nozzle associated with the casing for connection to an external source of water, the inlet nozzle configured for generating a stream of water directed towards the blades so as to rotate the rotor, (e) a reservoir deployed beneath the bottom drainage opening for receiving water draining from the casing; and (f) a drainage outlet formed in the reservoir for allowing drainage of water from the reservoir to a remote drain.

According to a further feature of the present invention, a cross-section taken through a volume swept by the rotor passing through an axis of rotation of the rotor has a first area, and wherein the bottom drainage opening has an area greater than half the first area.

According to a further feature of the present invention, the reservoir has an internal volume in excess of one liter, and preferably between about 5 and about 15 liters.

According to a further feature of the present invention, the reservoir is vented to the atmosphere.

According to a further feature of the present invention, the casing and the reservoir together form a unit sealed other than at the inlet nozzle and the drainage outlet.

### BRIEF DESCRIPTION OF THE DRAWINGS

The invention is herein described, by way of example only, with reference to the accompanying drawings, wherein:

FIG. 1 is a schematic cross-sectional view taken through a conventional domestic water turbine motor with an outlet drainage hose;

FIG. 2 is an enlarged view of a part of the turbine motor of FIG. 1;

FIG. 3 is a further enlarged view of the turbine motor of FIG. 1 illustrating the problem of water accumulation within the motor casing;

FIG. 4 is a schematic cross-sectional view taken through a first embodiment of a water turbine motor constructed and operative according to the teachings of the present invention;

FIG. 5 is a schematic cross-sectional view taken through a second embodiment of a water turbine motor constructed and operative according to the teachings of the present invention; and

FIG. 6 is a schematic horizontal cross-sectional view taken through the axis of rotation of a rotor of the turbine motor of FIG. 4.

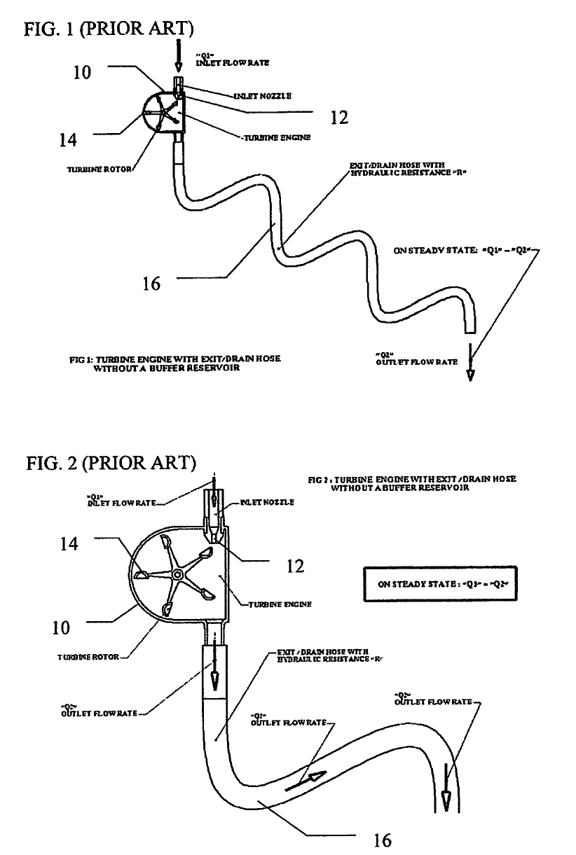

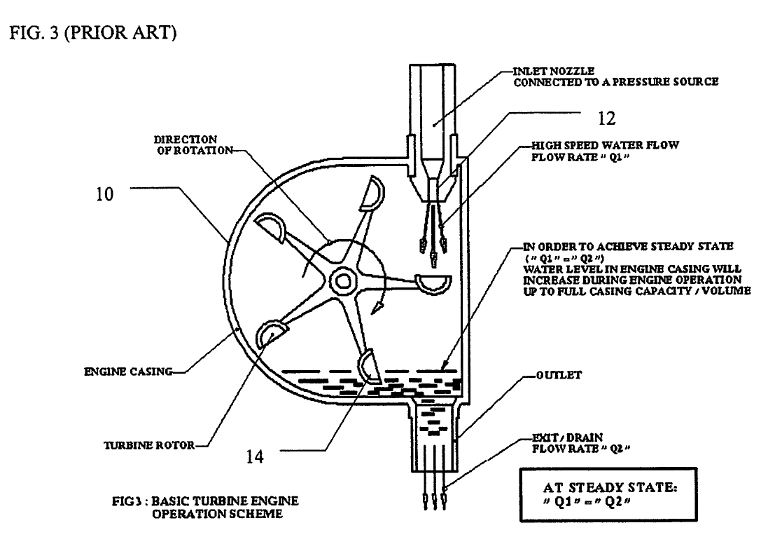

### DESCRIPTION OF THE PREFERRED EMBODIMENTS

The present invention is a domestic water-powered turbine motor with an outlet buffer reservoir.

The principles and operation of turbine motors according to the present invention may be better understood with reference to the drawings and the accompanying description.

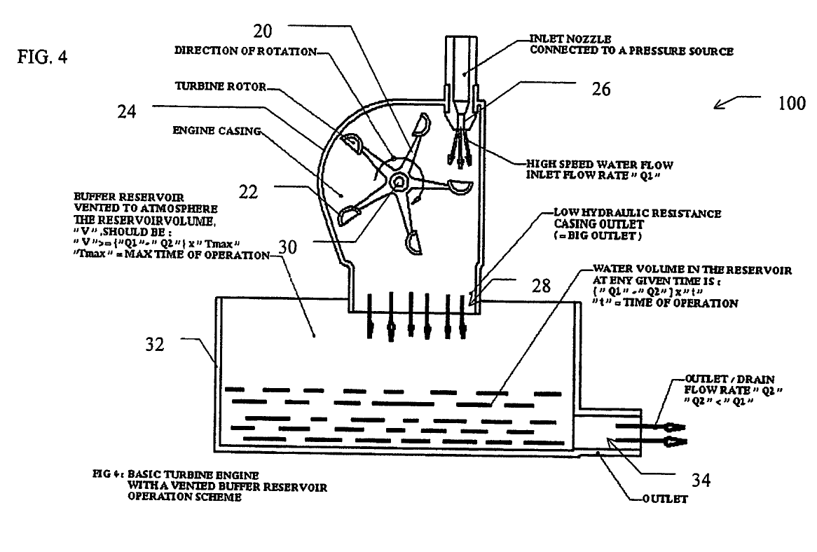

Referring now to the drawings, FIGS. 4-6 show two embodiments of a water-powered turbine motor, generally designated 100 and 200, respectively, constructed and operative according to the teachings of the present invention. Generally speaking, turbine motors 100 and 200 both include a rotor 20 with a plurality of blades 22 rotatably mounted within a casing 24. Associate with casing 24 is an inlet nozzle 26 configured such that, when connected to an external source of water, it generates one or more stream of water directed towards blades 22 so as to rotate rotor 20. Casing 24 also has a bottom drainage opening 28. An output shaft 30 is mechanically linked so as to rotate with rotor 20 to provide the power output coupling of the motor.

It is a particular feature of the present invention that motor 100 and 200 further include a reservoir 32 deployed beneath drainage opening 28 for receiving water draining from casing 24. Reservoir 32 has a drainage outlet 34 for allowing drainage of water, typically via a drainage hose (not shown) from reservoir 32 to a remote drain.

It will immediately be appreciated that the present invention provides a highly effective solution to the aforementioned problem of water accumulation within the motor due to drainage impedance. Specifically, by providing a buffer reservoir between the motor casing and the drainage outlet, the present invention ensures that water drains freely from the motor casing so as to avoid water accumulation within the casing. As a result, the casing remains essentially air-filled, thus ensuring minimum drag to oppose rotation of the rotor. This and other advantages of the present invention will be better understood from the following description.

Before addressing the features of the present invention in more detail, it will be helpful to define certain terminology as used herein in the description and claims. Firstly, the present invention is referred to as a “turbine motor”. This terminology is used herein to refer generically to any motor in which a rotating element (referred to as the “rotor”) is caused to rotate by transfer of momentum from a flow of liquid directed asymmetrically relative to the axis of rotation. Examples of motors falling within this definition include all devices working on the principles of water wheels, impeller motors and turbines of all sorts. In particular, the present invention relates to turbine motors suitable for being powered by connection to a domestic water supply. This typically means that the turbine motors of the present invention satisfy one or more of the following conditions: all parts exposed to the working fluid are resistant to corrosion under exposure to water; the nozzle is designed for operating under supply pressures of 2-7 atmospheres; the motor preferably operates with inlet flow rates of at least about 3 liters per minute, more preferably between about 5 and about 15 liters per minute, and most preferably around 10 liters per minute.

Reference is also made to “blades” of the turbine rotor. It should be appreciated that the term “blade” is used herein to refer generically to surfaces of the rotor against which the water flow impinges independent of the shape or configuration of these surfaces. Thus, the “blades” may be flat, curved or angled blades or cups, or any other configuration which provides surfaces deployed so as to be effective for deriving momentum from the water flow.

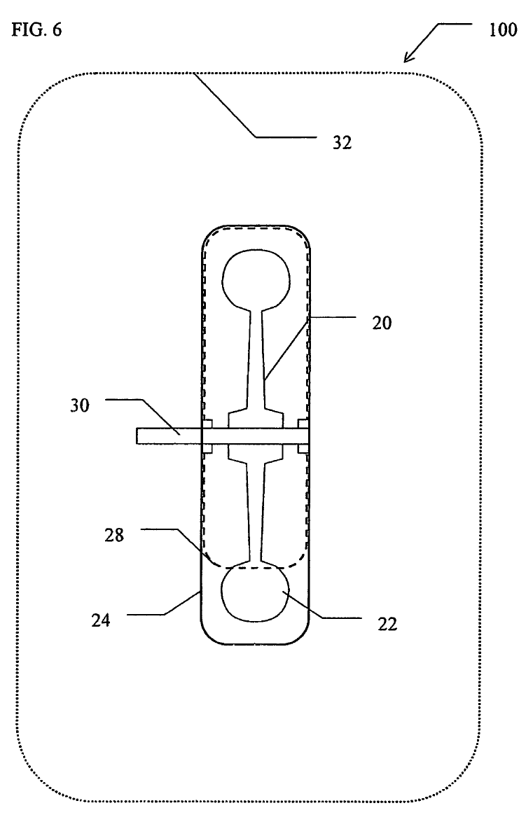

Turning now to the features of the present invention in more detail, it is a particularly preferred feature of the present invention that the bottom drainage opening 28 of casing 24 provides low hydraulic resistance to flow from the casing into reservoir 32. This is most easily achieved by forming casing 24 as an open-bottomed casing in which there is no bottom wall. In more precise terms, referring to the cross-sectional view of FIG. 6, the size of opening 28 (represented by a dashed line) may be defined in relation to the area of a cross-section of the volume swept by rotor 20. Specifically, FIG. 6 corresponds to a horizontal cross-section in a plane containing the axis of rotation of rotor 20. The region designated 20 in this figure actually corresponds to a cross-section of the volume swept by the rotor during rotation. Bottom drainage opening 28 preferably has an area greater than half the area of the rotor volume cross-section, and most preferably greater than the total area of the rotor volume cross-section. The area of bottom drainage opening 28 also preferably corresponds to a majority of the total area within casing 24 in the plane of the cross-section of FIG. 6.

Turning now to reservoir 32, this is provided by a housing which defines a volume in fluid connection with the internal volume of motor casing 24 but which is not required for rotation of the rotor. In most cases, the reservoir has a horizontal cross-section of area greater than that of the casing around the rotor as seen in FIG. 6, and has an internal volume many times greater than the volume swept out by the rotor.

In the embodiment of FIG. 4, reservoir 32 is vented to the atmosphere, typically simply by leaving an opening at the top of the reservoir. In this case, the air above water in the reservoir is always at atmospheric pressure, thereby ensuring that the inlet nozzle 26 operates with the maximum available pressure differential from the water supply. In this case, the quantity V of water in the reservoir at any time is given by:
V=(Q₁−Q₂)×t
where Q₁ is the rate of inlet flow at nozzle 26, Q₂ is the rate of drainage flow from outlet 34 and t is the period for which the motor has been operating. The volume of reservoir 32 should therefore be chosen according to these parameters so that it can hold the maximum amount of water expected to accumulate during the maximum likely period of operation. Thus, for example, if a motor has an input flow rate Q₁ of 7 liters per minute, a drainage rate Q₂ of 2 liters per minute and is normally used for up to 2 minutes of continuous operation at a time, reservoir 32 should be designed to hold at least (7-2)×2 which equals 10 liters A minimal implementation of the present invention would have a reservoir 32 of internal volume in excess of one liter, and most preferably, the volume is in the range between about 5 and about 15 liters.

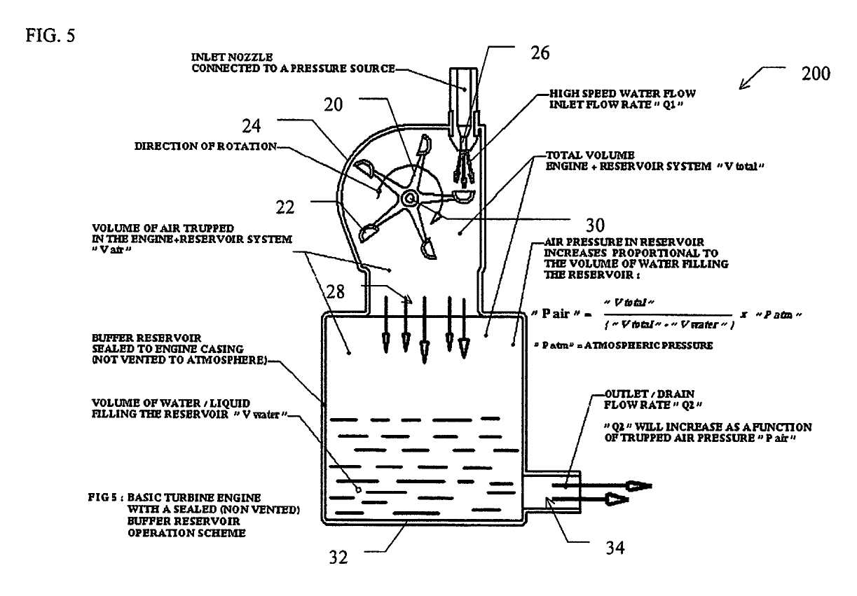

FIG. 5 illustrates an alternative embodiment in which casing 24 and reservoir 32 together form a unit sealed other than the aforementioned inlet nozzle 26 and drainage outlet 34. This implementation has advantages in the case of extended periods of operation since the closed system will build up pressure as the water level in the reservoir, thereby increasing the drainage outlet flow rate until an equilibrium state of Q₂=Q₁ is reached. The corresponding disadvantage is the effect of this pressure reducing the pressure differential acting across nozzle 26.

In other respects, motor 200 is similar to motor 100 and will be fully understood by analogy thereto.

It will be appreciated that the above descriptions are intended only to serve as examples, and that many other embodiments are possible within the scope of the present invention as defined in the appended claims.

What is claimed is:

1. A water-powered turbine motor comprising:
(a) a casing having a bottom drainage opening;
(b) a rotor having a plurality of blades, said rotor being rotatably mounted within said casing;
(c) an output shaft mechanically linked so as to rotate with said rotor;
(d) an inlet nozzle associated with said casing for connection to an external source of water, said inlet nozzle configured for generating a stream of water directed towards said blades so as to rotate said rotor;
(e) a reservoir deployed beneath said bottom drainage opening for receiving water draining from said casing; and
(f) a drainage outlet formed in said reservoir for allowing drainage of water from said reservoir to a remote drain.

2. The motor of claim 1, wherein a cross-section taken through a volume swept by said rotor passing through an axis of rotation of said rotor has a first area, and wherein said bottom drainage opening has an area greater than half said first area.

3. The motor of claim 1, wherein said reservoir has an internal volume in excess of one liter.

4. The motor of claim 1, wherein said reservoir has an internal volume between about 5 and about 15 liters.

5. The motor of claim 1, wherein said reservoir is vented to the atmosphere.

6. The motor of claim 1, wherein said casing and said reservoir together form a unit sealed other than at said inlet nozzle and said drainage outlet.
